(19) United States
(12) Patent Application Publication
(10) Pub. No.: US 2005/0049899 A1
(43) Pub. Date: Mar. 3, 2005

(54) Method and system for public facilities on-line reservation

(76) Inventors: Angel Lu, Taipei (TW); Ezoe Chang, Hsin-Tien City (TW); Sharon Huang, Taipei (TW)

Correspondence Address: LOWE HAUPTMAN GILMAN & BERNER, LLP, Suite 310, 1700 Diagonal Road, Alexandria, VA, 22314, US

(21) Appl. No.: 10/727,563

(22) Filed: Dec. 5, 2003

(30) Foreign Application Priority Data
Aug. 29, 2003 (TW) 92124024

(51) Int. Cl. G06F 17/60

(52) U.S. Cl. 705/5

(57) ABSTRACT

An on-line reservation method, storage medium with computer program and system for making a reservation for public facilities. A server is composed of a processor for performing a reservation transaction on public facilities by executing a program stored in a storage media. The staff log-in information, the operating instructions and approved reservation records of the public facilities are stored in the storage media connected to the processor. A client, being the terminal equipment, is used by the staff to connect the server by a network for submitting a reservation request for public facilities. Before making a reservation of the public facilities, an applicant checks the operating instructions and the approved reservation records. Then a reservation with a proper time span is requested, the server will transact the reservation as a new approved reservation record and store it in the storage media or show a suggested reservation time span for the applicant to modify his/her non-approved reservation request. Finally, the server will send an approved reservation notice to the applicant and notify the other relevant participators of this reservation application.

### BACKGROUND OF THE INVENTION

1. Field of the Invention

This invention relates to making a reservation for public facilities and more particularly to an on-line reservation method, a storage medium with computer program and a system for making a reservation for public facilities.

2. Description of the Prior Art

Traditionally, it is a manual process for staff to make a reservation for public facilities such as a conference room, a projector, and an official car in a company. An applicant has to submit a register to a manager during office hours. Before making a reservation, the applicant has to check every approved reservation record, page by page to find a proper time span. And after the applicant finished those time-consuming reservation processes, he/she has to notify each participators of this reservation one by one.

### SUMMARY OF THE INVENTION

The present invention has been made in view of the above problems, and the invention provides an on-line reservation method, storage medium with computer program and system for making reservations for public facilities. A client, being the terminal equipment, is used by an applicant to connect to the enterprise server through a network for submitting a reservation request for public facilities by the present invention. According to the present invention, the applicant could choose the time span on his/her reservation request from a group consisting of a single time span, multiple time spans and cyclic time spans to avoid wasting lots of time in the conventional reservation process.

The present invention also provides an on-line reservation method, storage medium with computer program and system for making reservations for public facilities. Before making a reservation, the applicant could propose a query request to check the operating instruction and every approved reservation record of the public facilities in advance, increasing the efficiency of the applicant to make reservations for public facilities.

The present invention still provides an on-line reservation method, storage medium with computer program and system for making reservations for public facilities. A client, being the terminal equipment, is used by the applicant to connect to the enterprise server through a network for submitting a cancellation request to cancel his/her approved reservation record by the present invention. The usage right of the applicant will be released and efficiently transferred to the next applicant.

The present invention further provides an on-line reservation method, computer program storaged in a medium and system for making reservations for public facilities. After making a reservation and the reservation time span of the reservation request is overlay with any approved time span of the plurality of approved reservation records, the applicant will receive a message of a suggested reservation time span to suggest he/she to modify the original reservation time span. The applicant doesn't have to check and modify his/her reservation request page by page, especially when he made a reservation request and the reservation time span is multiple or cyclic.

According to above discussion, an on-line reservation method, computer program and corresponding storage medium, and system for making a reservation for public facilities. A server is composed of a processor for performing a transaction on public facilities reservation by executing a program stored in a storage media. The staff log-in information, the operating instructions and approved reservation records of the public facilities are stored in the storage media connected to the processor. A client, such as terminal equipment, is used by the staff to connect the server, such as by a network, for submitting a reservation request for public facilities. Before making a reservation of the public facilities, an applicant checks the operating instructions and the approved reservation records. Then a reservation with a proper time span is requested, the server will transact the reservation to a new approved reservation record and store it in the storage media or show a suggested reservation time span for the applicant to modify his/her non-approved reservation request. Finally, the server will send an approved reservation notice to the applicant and notify the other relevant participators of this reservation application.

Additional contents and advantages of this invention will be apparent from the following detailed description of some preferred embodiments thereof that proceeds with reference to the accompanying drawings.

### BEIEF DESCRIPTION OF THE DRAWINGS

FIG. 1 is a processing flow chart illustrating a preferred embodiment of an on-line reservation method that corresponds to a storage medium with computer program and a system for public facilities.

FIG. 2 is an on-line reservation system for public facilities.

FIG. 3 is another on-line reservation system for public facilities.

### DESCRIPTION OF THE PREFERRED EMBODIMENT

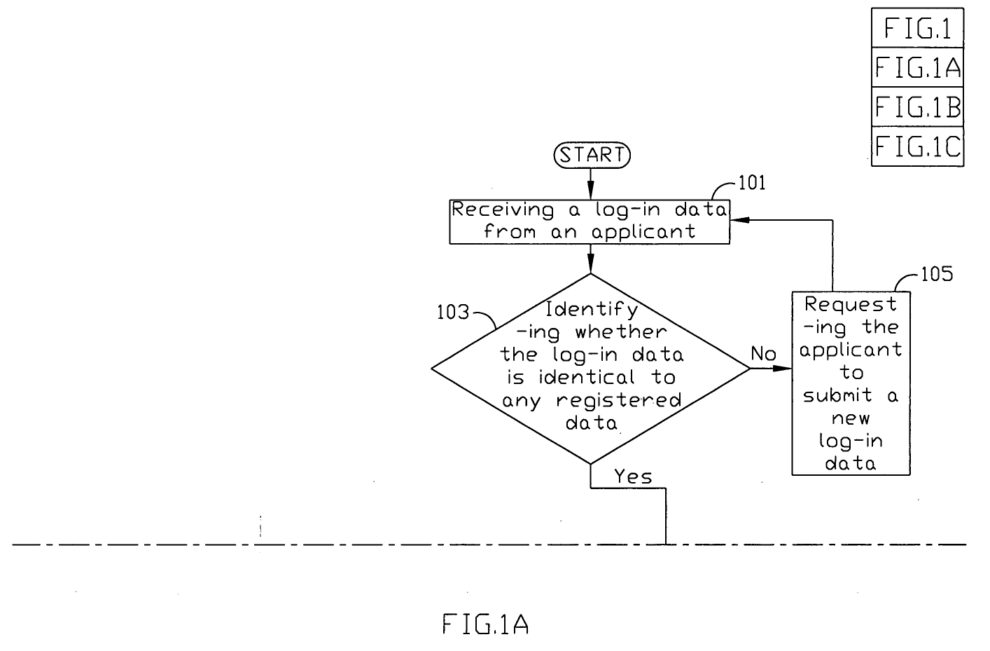

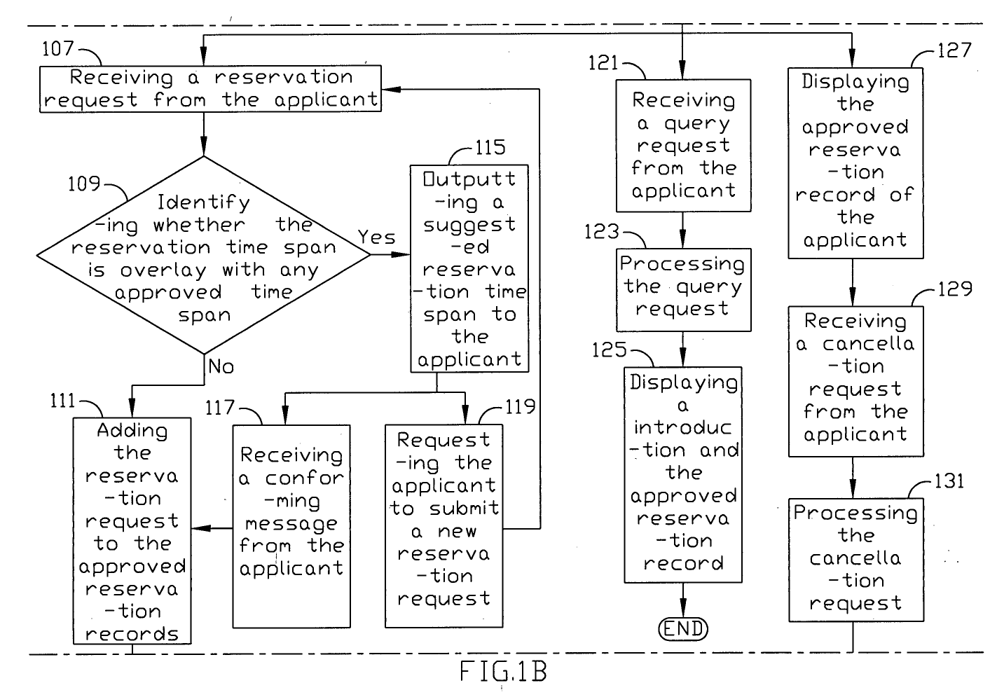

Referring to FIG. 1, which is a processing flow chart illustrating a preferred embodiment of an on-line reservation method, storage medium with computer program and system for public facilities of the present invention. First, a server (such as enterprise server, workstation and personal computer) is composed of a processing device and a storing device for performing a reservation transaction on public facilities. The storing device is responsible for storing a plurality of registered data for every staff of the enterprise to make a reservation for public facilities through the server, and each registered data contains a set of user name and corresponding user password for the staff member to reveal his/her identity. Moreover, the storing device is responsible for storing a plurality of approved reservation records, which correspond with a plurality of public facilities of the enterprise. Each of the approved reservation record contains information about an operating instruction, an approved time span, an approved name of an applicant and an approved name list of participators regarding the public facility of the enterprise. The present invention does not limit the enterprise server to a single server, a plurality of computer servers and personal computers connected by a network are included in the present invention to perform a reservation transaction on public facilities.

Next, the server receives a log-in data submitted from an applicant through a network, no matter internet or intranet (step of 101), wherein the log-in data contains a set of applicant name and the corresponding applicant password. The server identifies whether the log-in data is identical to any registered data stored in the storing device for every staff (step of 103) member. If the set of applicant name and corresponding applicant password of the log-in data is not identical to any set of user name and corresponding user password of the plurality of registered data, the server requests the applicant to submit new log-in data (step of 105). If the set of applicant name and corresponding applicant password of the log-in data is identical to any set of user name and corresponding user password of the plurality of registered data, the server performs a transaction selected by the applicant, executing one of the following steps: receiving a reservation request submitted from the applicant to make a reservation for public facilities (step of 107); receiving a query request submitted from the applicant to make a query about the approved reservation records of the public facilities (step of 121); and showing every corresponding approved reservation record of the applicant (step of 127), for the applicant's convenience in submitting a cancellation request at a later time.

When the server receives the reservation request submitted from the applicant to make a reservation for public facilities (step of 107). The reservation request contains information about a reservation time span, a reservation name of an applicant and a reservation name list of participators, and the time span is selected from a group consisting of a single time span, multiple time spans, and cyclic time spans of the reservation request. The server identifies whether the reservation time span of the reservation request overlap with any approved time span of the plurality of approved reservation records stored in the storing device (step of 109).

If the reservation time span does not overlap with an approved time span of the plurality of approved reservation records, the reservation request is accepted as a new approved reservation record and added to the approved reservation records (step of 111). Then the server will output the approved reservation notices to the applicant and the participators by using e-mail, ICQ, and other message ways (step of 113), according to the new approved reservation record.

If the reservation time span of the reservation request does overlap with any approved time span of the plurality of approved reservation records, the server could output a suggested reservation time span and a confirming request (step of 115). The suggested reservation time span is a time span advanced or postponed to the reservation time span of the plurality of approved reservation records, especially within the office hour. If the applicant agrees to the suggested reservation time span and sends a confirming message back to the server (step of 117), the reservation request is accepted as a new approved reservation record and added to the approved reservation records (step of 111). Then the server will output the approved reservation notices to the applicant and the participators by using e-mail, ICQ, and other message ways (step of 113), according to the new approved reservation record. And if the applicant doesn't agree to the suggested reservation time span and does not send a confirming message back to the server, the server will request the applicant to submit a new reservation request (step of 119). In the preferred embodiment of the present invention, when the reservation time span of the reservation request overlap with any approved time span of the plurality of approved reservation records, the server could be set to optionally output a non-approved reservation notice directly to the applicant, instead of outputting the suggested reservation time span and the confirming request.

When the server receives the query request submitted from the applicant to make a query about the approved reservation records of the public facilities (step of 121), and the query request contains questions about a corresponding introduction and a corresponding approved reservation record. The applicant could set specific terms of time spans in the query request to look up specific approved reservation records. The server processes the query request (step of 123), and then displays the corresponding introduction and the corresponding approved reservation records according to the query request (step of 125).

When the applicant chooses to cancel his/her approved reservation record, the server shows every corresponding approved reservation record of the applicant (step of 127) when the applicant name is identical to any approved name of the applicant of the plurality of approved reservation records. Then the server receives a cancellation request submitted from the applicant, wherein the cancellation request contains information about a cancellation time span (step of 129). The cancellation time span is selected from a group consisting of single time span, multiple time spans, and cyclic time spans of the cancellation request. The server identifies whether the cancellation time span of the cancellation request matches any approved time span of every corresponding approved reservation record (step of 131). If the cancellation time span matches any approved time span of the corresponding approved reservation record, the cancellation request is accepted and the corresponding approved reservation record is deleted (step of 133). Then the server will output cancellation notices to the applicant and the participators by using e-mail, ICQ, any short message way, and other message ways (step of 135), according to the deleted corresponding approved reservation record.

Another preferred embodiment of the present invention is a storage medium with computer program for on-line reserving public facilities, the computer program when executed by a computer causes the computer to perform above another preferred embodiment of the present invention. The computer program storaged on the storaged medium comprises a first program, a second program, a third program, a fourth program, a fifth program, a sixth program and a seventh program.

The first program performs to store a plurality of approved reservation records, which correspond with a plurality of public facilities. Each of the approved reservation record contains information about an approved time span, an approved name of an applicant and an approved name list of the participators. The second program performs the storage of a plurality of registered data. Each of the registered data contains a set of user name and corresponding user password. The third program performs to receive a log-in data submitted from an applicant, wherein the log-in data contains a set of applicant name and corresponding applicant password. The fourth program performs to identify the log-in data, then allows the applicant to submit a reservation request when the set of applicant name and corresponding applicant password of the log-in data is identical to any set of user name and corresponding user password of the plurality of registered data. The fifth program performs to receive the reservation request submitted from the applicant to make a query about the approved reservation records of the public facilities. The reservation request contains information about a reservation time span, a reservation name of an applicant and a reservation name list of participators, and the time span is selected from a group consisting of single time span, multiple time spans, and cyclic time spans of the reservation request. The sixth program performs to process the reservation request, and the reservation request is accepted as a new approved reservation record and added to the approved reservation records when the reservation time span of the reservation request doesn't overlap with any approved time span of the plurality of approved reservation records. The seventh program performs to output approved reservation notices to the applicant and the participators by using e-mail, ICQ, any short message way, and other short message ways according to the new approved reservation record.

In this preferred embodiment of the present invention, the fourth program performs to identify the log-in data. The fourth program could perform to request the applicant to submit a new log-in data when the set of applicant name and corresponding applicant password of the log-in data is not identical to any set of user name and corresponding user password of the plurality of registered data. The fourth program could also perform to allow the applicant to submit a query request when the set of applicant name and corresponding applicant password of the log-in data is identical to any set of user name and corresponding user password of the plurality of registered data. Afterward, the fourth program could perform to receive the query request submitted from the applicant, wherein the query request contains questions about a corresponding introduction and a corresponding approved reservation record. Finally, the fourth program could perform to display the corresponding introduction and the corresponding approved reservation record.

The fourth program could still perform to allow the applicant to cancel his/her approved reservation record when the set of applicant name and corresponding applicant password of the log-in data is identical to any set of user name and corresponding user password of the plurality of registered data. Afterward, the fourth program could perform to output every corresponding approved reservation record of the applicant, when the applicant name is identical to any approved name of the applicant of the plurality of approved reservation records. Next, the fourth program could perform to receive the cancellation request submitted from the applicant. The cancellation request contains information about a cancellation time span, and the cancellation time span is selected from a group consisting of a single time span, multiple time spans and cyclic time spans. Then the fourth program could perform to process the cancellation request, and the cancellation request is accepted and each corresponding approved reservation record of the applicant is deleted when the cancellation time span matches any approved time span of the plurality of approved reservation records. Finally, the fourth program could perform to output cancellation notices to the applicant and the participators by using e-mail, ICQ, any short message and other short message ways, according to the deleted corresponding approved reservation record.

In this preferred embodiment of the present invention, the fifth program performs to receive and could perform to process the reservation request. The fifth program could perform to output a suggested reservation time span and a confirming request when the reservation time span overlaps with any approved time span of the plurality of approved reservation records. Then the fifth program could perform one of the following steps: accepting the reservation request as a new approved reservation record and adding to the approved reservation records when a confirming message received from the applicant; and requesting the applicant to submit a new reservation request.

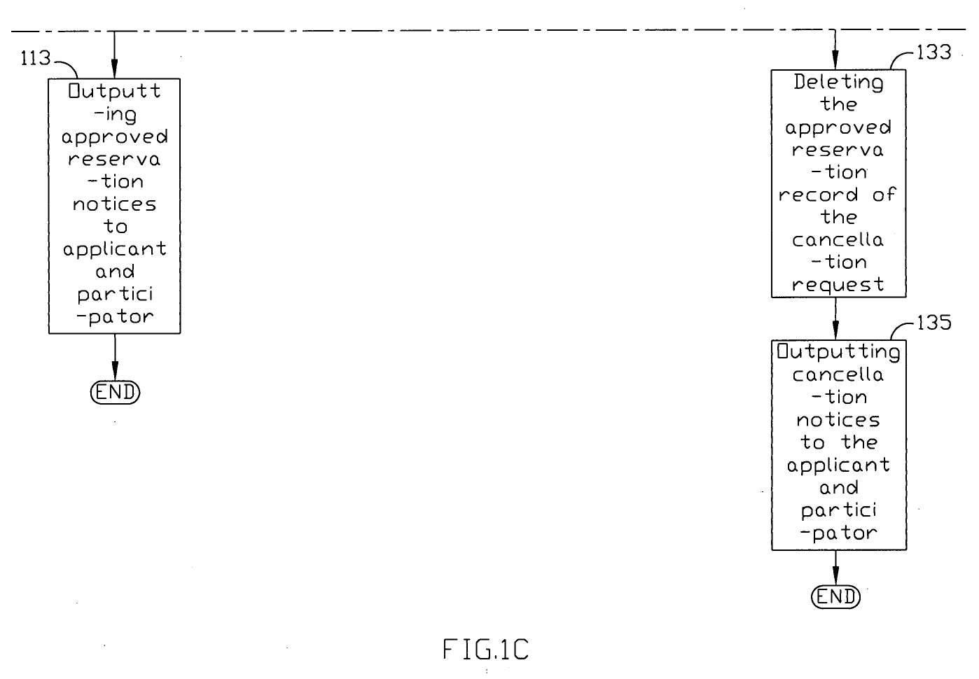

Still a preferred embodiment of the present invention is an on-line reservation system for public facilities. Referring to FIG. 2, the on-line reservation system comprises a storing device 201 and a processing device 203.

Referring to FIG. 2, the storing device 201 performs to store a plurality of registered data and a plurality of approved reservation records of a plurality of public facilities. Each of the registered data contains a set of user name and corresponding user password. Each of the approved reservation record contains information about an approved time span, an approved name of an applicant and an approved name list of participators, and the approved time span is selected from a group consisting of single time span, multiple time spans, and cyclic time spans. The processing device 203 could perform to receive a log-in data submitted from an applicant, wherein the log-in data contains a set of applicant name and corresponding applicant password. Afterward, the processing device 203 could perform to identify the log-in data, and to allow the applicant to submit a reservation request when the set of applicant name and corresponding applicant password of the log-in data is identical to any set of user name and corresponding user password of the plurality of registered data. Next, the processing device 203 could perform to receive the reservation request submitted from the applicant, wherein the reservation request contains information about a reservation time span, a reservation name of an applicant and a reservation name list of participators. Then the processing device 203 could perform to process the reservation request, and the reservation request is accepted to be a new approved reservation record and added to the approved reservation records when the reservation time span doesn't overlap with any approved time span of the plurality of approved reservation records stored in the storing device 201. Finally, the processing device 203 could perform to output the approved reservation notices to the applicant and the participators by using e-mail, ICQ, any short message way, and other short message ways according to the new approved reservation record.

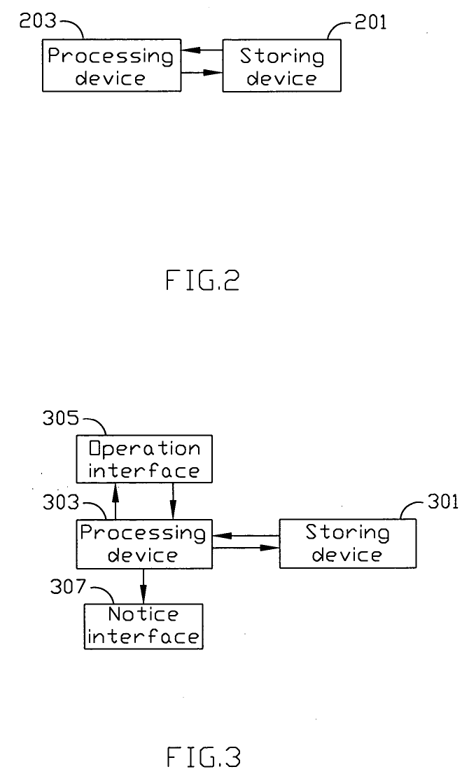

Referring to FIG. 3, still another preferred embodiment of the present invention is an on-line reservation system for public facilities. The on-line reservation system comprises not only a storing device 301 and a processing device 303. The on-line reservation system further comprises an operation interface 305 for receiving any message submitted from an applicant and a notice interface 307 for outputting the application result (approval/non-approval) of the reservation request to the applicant and relevant participators.

While the present invention described in detail and pictorially in the accompanying drawings, the present invention is not limited to such details many changes and modifications recognizable to those of ordinary skill in the art may be made to the invention without departing from the spirit and the scope thereof.

1. A on-line reservation method for public facility, comprising the steps of:
storing a plurality of approved reservation records corresponding a plurality of public facilities on a computer, wherein each said approved reservation record contains information about an approved time span, an approved name of an applicant and an approved name list of participators;
storing a plurality of registered data on said computer, wherein each said registered data containing a set of user name and corresponding user password;
receiving a log-in data submitted from a applicant on said computer, wherein said log-in data containing a set of applicant name and corresponding applicant password;
identifying said log-in data on said computer, and allowing said applicant to submit a reservation request when said set of applicant name and corresponding applicant password of said log-in data is identical to any set of user name and corresponding user password of said plurality of registered data;
receiving said reservation request submitted from said applicant on said computer, wherein said reservation request containing information about a reservation time span, a reservation name of an applicant corresponding to said reservation span and a reservation name list of participators;
processing said reservation request on said computer, and said reservation request is accepted to be a new approved reservation record and added to said approved reservation records when said reservation time span is not overlapped with any approved time span of said plurality of approved reservation records; and
outputting an approved reservation notices according to said reservation name of said applicant and said reservation name list of participators on said computer when said reservation request was accepted to be said new approved reservation record.

2. The method according to claim 1, wherein any of said public facilities corresponds to an operating instruction, and said reservation time span is selected from a group consisting of single time span, multiple time spans, and cyclic time spans of said reservation request.

3. The method according to claim 1, further comprising the step of:
requesting said applicant to submit a new log-in data when said set of applicant name and corresponding applicant password of said log-in data is not identical to any set of user name and corresponding user password of said plurality of registered data.

4. The method according to claim 1, further comprising the steps of:
allowing said applicant to submit a query request when said set of applicant name and corresponding applicant password of said log-in data is identical to any set of user name and corresponding user password of said plurality of registered data;
receiving said query request submitted from said applicant, wherein said query request contains questions about a corresponding introduction and a corresponding approved reservation record; and
displaying said corresponding introduction and said corresponding approved reservation record.

5. The method according to claim 1, further comprising the steps of:
allowing said applicant to submit a cancellation request when said set of applicant name and corresponding applicant password of said log-in data is identical to any set of user name and corresponding user password of said plurality of registered data;
outputting and displaying every corresponding approved reservation record of said applicant when said applicant name is identical to any approved name of applicant of said plurality of approved reservation records;
receiving said cancellation request submitted from said applicant, wherein said cancellation request contains information about a cancellation time span;
processing said cancellation request, and said cancellation request is accepted and each corresponding approved reservation record of said applicant is deleted when said cancellation time span matches any approved time span of said plurality of approved reservation records; and
optionally outputting cancellation notices according to said reservation name of said applicant and said reservation name list of participators of each deleted corresponding approved reservation record.

6. The method according to claim 5, wherein said cancellation time span is selected from a group consisting of single time span, multiple time spans, and cyclic time spans of said cancellation request.

7. The method according to claim 1, further comprising the step of:
outputting a suggested reservation time span when said reservation time span is overlapped with any approved time span of said plurality of approved reservation records.

8. The method according to claim 7, further comprising performance of any one of two steps as following:
outputting said suggested reservation time span, and said reservation request is accepted to be a new approved reservation record and added to said approved reservation records when receiving a confirm message about said suggested reservation time span sent from said applicant; and
outputting said suggested reservation time span, and requesting said applicant to submit a new reservation request.

9. A storage medium for storing controlling program of on-line reservation of public facilities, containing data that can be read by a computer and used to allow reservation of said public facility on the computer, comprising:
a first program for storing a plurality of approved reservation records corresponding a plurality of public facilities on said computer, wherein each said approved reservation record contains information about an approved time span, an approved name of an applicant and an approved name list of participators;
a second program for storing a plurality of registered data on said computer, wherein each said registered data contains a set of user name and corresponding user password;
a third program for receiving a log-in data submitted from a applicant on said computer, wherein said log-in data containing a set of applicant name and corresponding applicant password;
a fourth program for identifying said log-in data on said computer, and allowing said applicant to submit a reservation request when said set of applicant name and corresponding applicant password of said log-in data is identical to any set of user name and corresponding user password of said plurality of registered data;
a fifth program for receiving said reservation request submitted from said applicant on said computer, wherein said reservation request containing information about a reservation time span, a reservation name of an applicant and a reservation name list of participators;
a sixth program for processing said reservation request on said computer, and said reservation request is accepted to be a new approved reservation record and added to said approved reservation records when said reservation time span is not overlapped with any approved time span of said plurality of approved reservation records; and
a seventh program for outputting approved reservation notices according to said reservation name of said applicant and said reservation name list of participators of said new approved reservation record on said computer.

10. The storage medium for storing controlling program of on-line reservation of public facilities according to claim 9, wherein any of said public facilities corresponds to an operating instruction, and said reservation time span is selected from a group consisting of single time span, multiple time spans, and cyclic time spans of said reservation request.

11. The storage medium for storing controlling program of on-line reservation of public facilities according to claim 9, wherein said fourth program further makes the computer perform step of:
requesting said applicant to submit a new log-in data when said set of applicant name and corresponding applicant password of said log-in data is not identical to any set of user name and corresponding user password of said plurality of registered data.

12. The storage medium for storing controlling program of on-line reservation of public facilities according to claim 9, wherein said fourth program further makes the computer perform steps of:
allowing said applicant to submit a query request when said set of applicant name and corresponding applicant password of said log-in data is identical to any set of user name and corresponding user password of said plurality of registered data;
receiving said query request submitted from said applicant, wherein said query request comprises questions about a corresponding approved reservation record to said public facilities; and
displaying introduction and approved reservation record corresponded by said public facilities.

13. The storage medium for storing controlling program of on-line reservation of public facilities according to claim 9, wherein said fourth program further makes the computer perform steps of:
allowing said applicant to submit a cancellation request when said set of applicant name and corresponding applicant password of said log-in data is identical to any set of user name and corresponding user password of said plurality of registered data;
outputting corresponding approved reservation record of said applicant and displaying every corresponding approved reservation record of said applicant when said applicant name is identical to any approved name of applicant of said plurality of approved reservation records;
receiving said cancellation request submitted from said applicant, wherein said cancellation request contains information about a cancellation time span;
processing said cancellation request, and said cancellation request is accepted and each corresponding approved reservation record of said applicant is deleted when said cancellation time span matches any approved time span of said plurality of approved reservation records; and
optionally outputting cancellation notices according to said reservation name of said applicant and said reservation name list of participators of each deleted corresponding approved reservation record.

14. The storage medium for storing controlling program of on-line reservation of public facilities according to claim 13, wherein said cancellation time span is selected from a group consisting of single time span, multiple time spans, and cyclic time spans of said cancellation request.

15. The storage medium for storing controlling program of on-line reservation of public facilities according to claim 9, wherein said fifth program further makes said computer perform step of:
outputting a suggested reservation time span when said reservation time span is overlapped with any approved time span of said plurality of approved reservation records.

16. The storage medium for storing controlling program of on-line reservation of public facilities according to claim 15, wherein said fifth program makes said computer perform any one of two possible variations as following:
outputting said suggested reservation time span, and said reservation request is accepted to be a new approved reservation record and added to said approved reservation records when received a confirm message about said suggested reservation time span sent from said applicant; and
outputting said suggested reservation time span, and requesting said applicant to submit a new reservation request.

17. An on-line reservation system for public facility, comprising:
a storing device for storing a plurality of corresponding registered data and a plurality of approved reservation records of a plurality of public facilities, wherein each said registered data contains a set of user name and corresponding user password, and each said approved reservation record contains information about an approved time span, an approved name of an applicant and an approved name list of participators; and
a processing device for performing the steps of:
receiving a log-in data submitted from an applicant, wherein said log-in data containing a set of applicant name and corresponding applicant password;
identifying said log-in data, and allowing said applicant to submit a reservation request when said set of applicant name and corresponding applicant password of said log-in data is identical to any set of user name and corresponding user password of said plurality of registered data;
receiving said reservation request submitted from said applicant, wherein said reservation request containing information about a reservation time span, a reservation name of an applicant and a reservation name list of participators;
processing said reservation request, and said reservation request is accepted to be a new approved reservation record and added to said approved reservation records when said reservation time span is not overlapped with any approved time span of said plurality of approved reservation records, wherein said approved reservation records are stored in said storing device; and
outputting approved reservation notices according to said reservation name of said applicant and said reservation name list of participators when said reservation request was accepted to be said new approved reservation record.

18. The system according to claim 17, wherein any of said public facilities corresponds to an operating instruction, and said reservation time span is selected from a group consisting of single time span, multiple time spans, and cyclic time spans of said reservation request.

19. The system according to claim 17, further comprising an operation interface for receiving any message submitted from said applicant.

20. The system according to claim 17, further comprising a notice interface for outputting an application result of said reservation request to said applicant and relevant participators.
